(19) United States
(12) Patent Application Publication
(10) Pub. No.: US 2022/0270828 A1
(43) Pub. Date: Aug. 25, 2022

(54) SOLID ELECTROLYTIC CAPACITOR

(71) Applicant: TOKIN Corporation, Sendai-shi (JP)

(72) Inventors: Kazuaki SAITO, Sendai-shi (JP); Masami ISHIJIMA, Sendai-shi (JP); Kenji ARAKI, Sendai-shi (JP); Daisuke TAKADA, Sendai-shi (JP)

(21) Appl. No.: 17/667,318

(22) Filed: Feb. 8, 2022

(30) Foreign Application Priority Data
Feb. 25, 2021 (JP) 2021-028437

(51) Int. Cl. H01G 9/012; H01G 9/15

(52) U.S. Cl. CPC H01G 9/012; H01G 9/15

(57) ABSTRACT

A solid electrolytic capacitor according to an aspect of the present disclosure includes a tantalum lead-out wire and a capacitor element. The capacitor element includes an anode body, a dielectric layer, a solid electrolyte layer, and a cathode body. The tantalum lead-out wire penetrates the capacitor element in a penetrating direction, cross sections of the tantalum lead-out wire and the capacitor element perpendicular to the penetrating direction include a rectangular shape, a longitudinal direction of the cross sections extending in a horizontal direction, and a value of Wc/Wd is less than 0.5, where We is a vertical length of the cross section of the tantalum lead-out wire perpendicular to the penetrating direction and Wd is a vertical length of the cross section of the capacitor element perpendicular to the penetrating direction.

### CROSS-REFERENCE TO RELATED APPLICATION

The present application claims priority to Japanese Patent Application No. 2021-28437 filed on Feb. 25, 2021. The entire contents of the above-listed application is incorporated by reference for all purposes.

### BACKGROUND

The present disclosure relates to a solid electrolytic capacitor.

In recent years, solid electrolytic capacitors have been widely used in various fields such as electronic equipment. Japanese Unexamined Patent Application Publication No. 2004-7105 discloses a technique related to a noise filter including a tantalum thin wire, a capacitance forming part provided around the tantalum thin wire, and a conductor layer provided around the capacitance forming part. The noise filter including a solid electrolytic capacitor disclosed in Japanese Unexamined Patent Application Publication No. 2004-7105 has a three-terminal structure in which the thin tantalum wire penetrates the capacitance forming part.

### SUMMARY

With the miniaturization of electronic equipment in recent years, there is a demand for the miniaturization and thinning of solid electrolytic capacitors. The noise filter including the solid electrolytic capacitor disclosed in Japanese Unexamined Patent Application Publication No. 2004-7105 has a tantalum thin wire with a cylindrical structure, that is, the cross-sectional shape of the tantalum thin wire is circular, and thus it is difficult to achieve reduced size and thickness of the solid electrolytic capacitor.

On the other hand, by forming a tantalum lead-out wire into a flat shape, that is, if a cross section thereof is made rectangular, the size and thickness of the solid electrolytic capacitor can be reduced. However, when the tantalum lead-out wire has a rectangular cross section, a manufacturing yield may deteriorate if a relationship between the size of the tantalum lead-out wire and the size of the capacitor element is not properly set.

In view of the above problem, an object of the present disclosure is to provide a solid electrolytic capacitor capable of improving a manufacturing yield while achieving reduction in size and thickness of the solid electrolytic capacitor.

A solid electrolytic capacitor according to an example aspect of the present disclosure includes a tantalum lead-out wire and a capacitor element. The capacitor element includes: an anode body formed of a valve metal and covering a periphery of a middle part of the tantalum lead-out wire; a dielectric layer formed on a surface of the anode body; a solid electrolyte layer formed on a surface of the dielectric layer; and a cathode body formed on a surface of the solid electrolyte layer. The tantalum lead-out wire penetrates the capacitor element in a penetrating direction, cross sections of the tantalum lead-out wire and the capacitor element perpendicular to the penetrating direction include a rectangular shape, a longitudinal direction of the cross sections extending in a horizontal direction, and a value of Wc/Wd is less than 0.5, where We is a vertical length of the cross section of the tantalum lead-out wire perpendicular to the penetrating direction and Wd is a vertical length of the cross section of the capacitor element perpendicular to the penetrating direction.

According to the present disclosure, it is possible to provide a solid electrolytic capacitor capable of improving a manufacturing yield while achieving reduction in size and thickness of the solid electrolytic capacitor.

The above and other objects, and features of the present disclosure will become more fully understood from the detailed description given hereinbelow and the accompanying drawings which are given by way of illustration only, and thus are not to be considered as limiting the present disclosure.

### BRIEF DESCRIPTION OF THE FIGURES

FIG. 1 is a side view showing an example of a solid electrolytic capacitor according to an embodiment;

FIG. 2 is a top view showing an example of the solid electrolytic capacitor according to the embodiment;

FIG. 3 is a partial cross-sectional view of a central part taken along the cutting line of FIG. 1;

FIG. 4 is a cross-sectional view of a part of a capacitor element taken along the cutting line IV-IV of FIG. 2;

FIG. 5 is a table showing a relationship between a value of Wc/Wd and a failure rate;

FIG. 6 is a table showing a relationship between a value of YA/PA and an impedance at each frequency;

FIG. 7 is a table showing the relationship between a value of Wa/Wb and an impedance at each frequency;

FIG. 8 is a diagram for explaining advantages of the present disclosure;

FIG. 9 is a diagram for explaining advantages of the present disclosure;

FIG. 10 is a diagram for explaining advantages of the present disclosure;

FIG. 11 is a perspective view showing a configuration example of the solid electrolytic capacitor according to the embodiment;

FIG. 12 is a perspective view showing a configuration example of the solid electrolytic capacitor according to the embodiment;

FIG. 13 is a perspective view showing a configuration example of the solid electrolytic capacitor according to the embodiment;

FIG. 14 is a perspective view showing a configuration example of the solid electrolytic capacitor according to the embodiment;

FIG. 15 is a perspective view showing a configuration example of the solid electrolytic capacitor according to the embodiment;

FIG. 16 is a perspective view for explaining an example of manufacturing the solid electrolytic capacitor according to the embodiment; and

FIG. 17 is a perspective view for explaining an example of manufacturing the solid electrolytic capacitor according to the embodiment.

### DETAILED DESCRIPTION

Embodiments of the present disclosure will be described below with reference to the drawings.

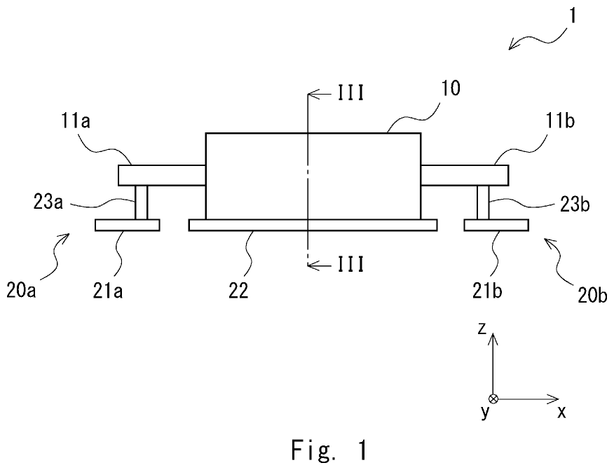

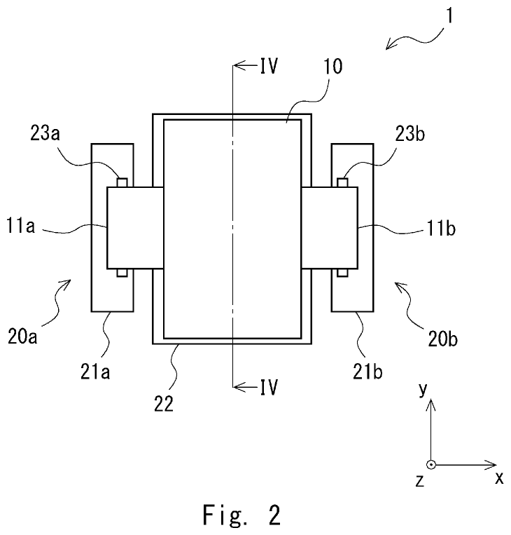

FIGS. 1 and 2 are a side view and a top view, respectively, showing an example of a solid electrolytic capacitor according to this embodiment. As shown in FIGS. 1 and 2, a solid electrolytic capacitor 1 according to this embodiment includes a capacitor element 10 and tantalum lead-out wires 11a and 11b. In this specification, the tantalum lead-out wires 11a and 11b may be collectively referred to as tantalum lead-out wires 11. The same applies to other components such as anode lead frames 20a and 20b.

The tantalum lead-out wires 11 penetrate the capacitor element 10 in a penetrating direction, which is an x-axis direction. The tantalum lead-out wires 11a and 11b, which are exposed parts of the tantalum lead-out wires 11 from the capacitor element 10, constitute anode lead-out wires, respectively. The tantalum lead-out wires 11a and 11b, i.e., the anode lead-out wires, are connected to the anode lead frames 20a and 20b, respectively.

Specifically, the anode lead frames 20a and 20b include pedestal parts 21a and 21b extending in a horizontal direction, which is the x-axis direction, respectively, and erected parts 23a and 23b erected in a vertical direction, which is a z-axis direction, from the pedestal parts 21a and 21b, respectively. The tantalum lead-out wires 11a and 11b, i.e., the anode lead-out wires, are connected to top surfaces of the erected parts 23a and 23b, respectively, thereby electrically connecting the tantalum lead-out wires 11a and 11b, i.e., the anode lead-out wires, to the anode lead frames 20a and 20b, respectively. For example, the tantalum lead-out wires 11a and 11b, i.e., the anode lead-out wires, are connected to the erected parts 23a and 23b, respectively, by welding. The pedestal parts 21a and 21b are connected to a substrate (not shown).

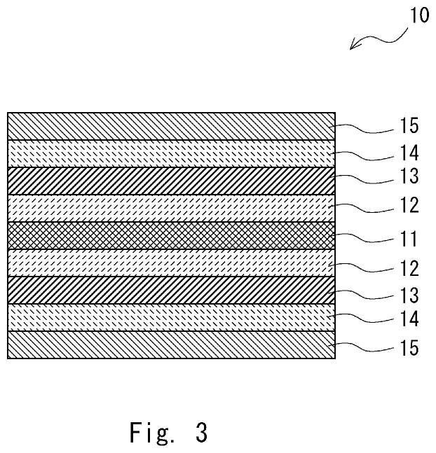

A cathode body 15 (see FIG. 3) of the capacitor element 10 is electrically connected to the cathode terminal 22 on a lower surface side of the capacitor element 10, namely, a negative side in the z-axis direction. For example, the cathode body 15 is connected to the cathode terminal 22 using a conductive adhesive. The cathode terminal 22 is connected to the substrate (not shown).

As described above, the solid electrolytic capacitor 1 according to this embodiment has a three-terminal structure in which the tantalum lead-out wires 11a and 11b are connected to the anode lead frames 20a and 20b, respectively, at two positions, and the cathode body 15 (see FIG. 3) is connected to the cathode terminal 22 at one position.

FIG. 3 is a cross-sectional view for explaining an internal structure of the capacitor element 10, and is a partial cross-sectional view of a central part taken along the cutting line of FIG. 1. As shown in FIG. 3, the capacitor element 10 includes an anode body 12, a dielectric layer 13, a solid electrolyte layer 14, and the cathode body 15. The tantalum lead-out wire 11 is disposed in the center of the capacitor element 10.

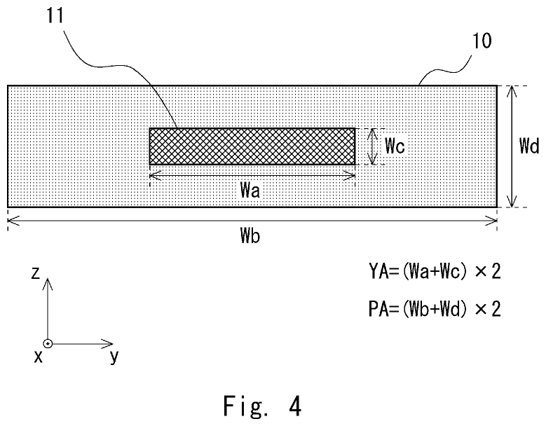

The tantalum lead-out wire 11 is formed of metallic tantalum (Ta). The tantalum lead-out wire 11 has a rectangular cross section in an yz plane (see FIG. 4), and can be formed, for example, by rolling a tantalum lead-out wire having a cylindrical structure.

The anode body 12 covers the periphery of the middle part of the tantalum lead-out wire 11, specifically, covers parts of the tantalum lead-out wire exposed from the capacitor element 10 other than the tantalum lead-out wires 11a and 11b. The anode body 12 can be formed using tantalum (Ta), which is a valve metal. The tantalum lead-out wire 11 and the anode body 12 may be integrally formed.

The dielectric layer 13 is formed on a surface of the anode body 12. For example, the dielectric layer 13 can be formed by anodizing the surface of the anode body 12. For example, when tantalum is used for the anode body 12, a tantalum oxide film, namely, the dielectric layer 13, can be formed on the surface of the anode body 12 by anodizing the anode body 12. For example, the thickness of the dielectric layer 13 can be appropriately adjusted by a voltage of the anodization.

The solid electrolyte layer 14 is formed on a surface of the dielectric layer 13. For example, the solid electrolyte layer 14 can be formed using a conductive polymer. In order to form the solid electrolyte layer 14, for example, chemical oxidation polymerization or electrolytic polymerization may be used. Alternatively, the solid electrolyte layer 14 may be formed by coating or impregnating a workpiece with a conductive polymer solution and drying it.

The solid electrolyte layer 14 may include, for example, a polymer composed of a monomer including at least one kind of pyrrole, thiophene, aniline, and derivative thereof. In addition, a sulfonic acid-based compound may be included as a dopant. In addition to the above conductive polymer, the solid electrolyte layer 14 may include an oxide material such as manganese dioxide and ruthenium oxide, and an organic semiconductor such as TCNQ (7,7,8,8-tetracyanoquinodimethane complex salt).

The cathode body 15 is formed on a surface of the solid electrolyte layer 14. For example, the cathode body 15 may be formed of a graphite layer formed on the surface of the solid electrolyte layer 14 and a silver paste layer formed on the surface of the graphite layer. The cathode body 15 is connected to the cathode terminal 22 using a conductive adhesive on the lower surface side of the capacitor element 10, namely, a negative side in the z-axis direction.

FIG. 4 is a cross-sectional view taken along the cutting line IV-IV of FIG. 2, for explaining the cross-sectional shapes of the capacitor element 10 and the tantalum lead-out wire 11. In FIG. 4, the cathode terminal 22 is not shown. In this embodiment, a cross section, which is the yz plane, perpendicular to the penetrating direction, i.e., the x-axis direction, of the tantalum lead-out wire 11 and the capacitor element 10 has a rectangular shape in which a longitudinal direction (a y-axis direction) extends in the horizontal direction.

For example, a vertical length We of the cross section of the tantalum lead-out wire 11 may be 0.05 mm or more and 0.6 mm or less, and a horizontal length Wa thereof may be 0.2 mm or more and 3.3 mm or less. Further, a vertical length Wd of the cross section of the capacitor element 10 may be 0.3 mm or more and 1.2 mm or less, and the horizontal length Wb thereof may be 1.0 mm or more and 4.1 mm or less.

At this time, in the solid electrolytic capacitor 1 according to this embodiment, a value of Wc/Wd is set to be less than 0.5, or 0.3 or less, or 0.1 or more and 0.3 or less.

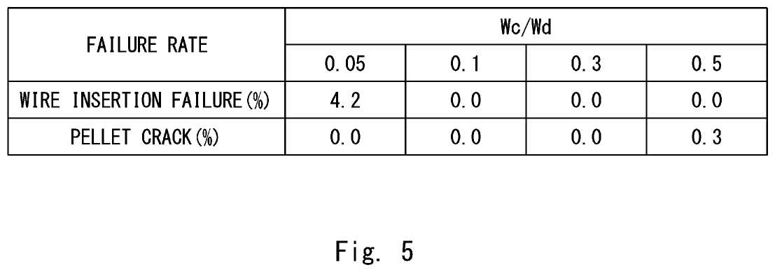

FIG. 5 is a table showing a relationship between the value of Wc/Wd and a failure rate. FIG. 5 shows a wire insertion failure rate and a pellet crack failure rate when the value of Wc/Wd is 0.05, 0.1, 0.3, and 0.5. Here, the wire insertion failure means, for example, deformation of a wire or exposure of a wire from the capacitor element due to inclination. The pellet crack failure means a failure in which a crack occurs in a pellet during pellet molding. The failure rate is a proportion (%) of the number of samples in which failures have occurred to the total number of samples. FIG. 5 shows a result when the total number of samples is 1,000.

As shown in FIG. 5, when the value of Wc/Wd is 0.5, the wire insertion failure rate is 0% and the pellet crack failure rate is 0.3%. When the value of Wc/Wd is 0.05, the wire insertion failure rate is 4.2% and the pellet crack failure rate is 0%. When the value of Wc/Wd is 0.1 and 0.3, the wire insertion failure rate and the pellet crack failure rate were both 0%. Therefore, when the value of Wc/Wd is less than 0.5, or 0.3 or less, or 0.1 or more and 0.3 or less, the wire insertion failure rate and the pellet crack failure rate can be reduced.

That is, when the value of Wc/Wd is 0.5 or more, it is considered that the thickness of the tantalum lead-out wire 11 with respect to the capacitor element 10, i.e., a pellet is increased, thereby increasing the cracking of the pellet. Furthermore, when the value of Wc/Wd is 0.05 or less, the thickness of the tantalum lead-out wire 11 with respect to the capacitor element 10, i.e., the pellet, is reduced, which is considered to have caused a wire insertion failure.

As described above, in the solid electrolytic capacitor according to this embodiment, the tantalum lead-out wire has a flat shape, that is, a cross section thereof is rectangular. Therefore, the size and thickness of the solid electrolytic capacitor can be reduced. Further, since the relationship between the size of the tantalum lead-out wire and that of the capacitor element, which is specifically, the relationship between Wc and Wd, is appropriately set, the manufacturing yield can be improved. Therefore, according to the present disclosure, it is possible to provide a solid electrolytic capacitor capable of improving the manufacturing yield while achieving reduction in the size and thickness of the solid electrolytic capacitor.

In the solid electrolytic capacitor described above, the cross-sectional shape of the tantalum lead-out wire 11 is rectangular. However, in this embodiment, the cross-sectional shape of the tantalum lead-out wire 11 also includes a substantially rectangular and a substantially flat shape, and may have, for example, fillets in the corners by being rounded or chamfered or may have a racetrack shape with both ends curved. The values of Wa and Wc can be obtained by measuring the maximum lengths in the vertical and horizontal directions, respectively.

In this embodiment, as shown in FIG. 4, when the length of the circumference of the cross section of the tantalum lead-out wire 11 is YA (YA=(Wa+Wc)×2) and the length of the circumference of the cross section of the capacitor element 10 is PA (PA=(Wb+Wd)×2), a value of YA/PA may be 0.1 or more and 0.9 or less, or 0.3 or more and 0.7 or less.

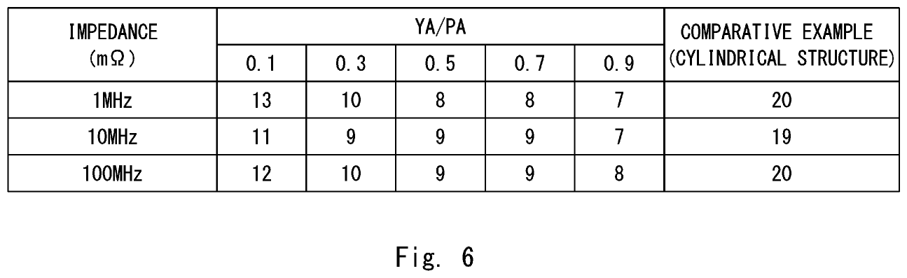

FIG. 6 is a table showing a relationship between the value of YA/PA and an impedance at each frequency. The table of FIG. 6 shows the impedance of the solid electrolytic capacitor 1 at frequencies of 1 MHz, 10 MHz, and 100 MHz when the values of YA/PA are 0.1, 0.3, 0.5, 0.7, and 0.9. Table 6 also shows, as a comparative example, an impedance when the cross-sectional shape of the tantalum lead-out wire is circular, specifically, when the tantalum lead-out wire has a cylindrical structure.

As shown in FIG. 6, when the tantalum lead-out wire 11 has a rectangular cross section, that is, when the value of YA/PA is 0.1 or more and 0.9 or less, a value of the impedance is lower as a whole than that in the case of the comparative example when the tantalum lead-out wire has a circular cross section. In particular, when the value of YA/PA is 0.3 or more and 0.9 or less, the value of the impedance is low.

Here, the value of YA/PA indicates a ratio of the length YA of the circumference of the cross section of the tantalum lead-out wire 11 to the length PA of the circumference of the cross section of the capacitor element 10. Therefore, the greater the value of YA/PA, the higher the ratio of the length YA of the circumference of the cross section of the tantalum lead-out wire 11 to the length PA of the circumference of the cross section of the capacitor element 10 becomes, and the larger the area where the tantalum lead-out wire 11 and the anode body 12 of the capacitor element 10 are brought into contact with each other becomes. Therefore, it is considered that the higher the value of YA/PA, the larger the area where the tantalum lead-out wire 11 and the anode body 12 are brought into contact with each other becomes, which reduces the contact resistance, and the lower the impedance value of the solid electrolytic capacitor becomes. Further, it is considered that the greater the value of YA/PA, the larger the surface area of the tantalum lead-out wire 11, and the phenomenon that an impedance in a high frequency region becomes high due to the skin effect can be eliminated or minimized, and thus the value of the impedance of the solid electrolytic capacitor becomes low.

On the other hand, the greater the value of YA/PA, the greater the value of We becomes, and the greater the value of Wc/Wd (see FIG. 5) also becomes. Therefore, there is a possibility that the pellet crack failure rate may become high. Further, the capacitance of the solid electrolytic capacitor is also reduced. In consideration of this point, it is necessary to set the value of YA/PA within an optimum range. In this embodiment, it is possible to set the value of YA/PA to 0.3 or more and 0.7 or less.

The solid electrolytic capacitor 1 according to this embodiment may have a value Wa/Wb of 0.2 or more and 0.8 or less, or 0.3 or more and 0.7 or less.

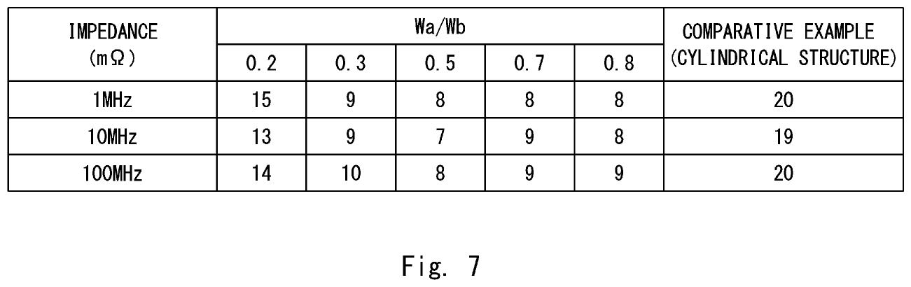

FIG. 7 is a table showing a relationship between the value Wa/Wb and an impedance at each frequency. The table of FIG. 7 shows the impedance of the solid electrolytic capacitor 1 at frequencies of 1 MHz, 10 MHz, and 100 MHz when the values of Wa/Wb are 0.2, 0.3, 0.5, 0.7, and 0.8. Table 7 shows, as a comparative example, an impedance when the cross-sectional shape of the tantalum lead-out wire is circular, specifically, when the tantalum lead-out wire has a cylindrical structure.

As shown in FIG. 7, when the tantalum lead-out wire 11 has a rectangular cross section, that is, when the value of Wa/Wb is 0.2 or more and 0.8 or less, a value of the impedance is lower as a whole than that in the case of the comparative example when the tantalum lead-out wire has a circular cross section. In particular, when the value of Wa/Wb is 0.3 or more and 0.8 or less, the value of the impedance is low.

Here, the value of Wa/Wb indicates a ratio of the longitudinal length Wa of the cross section of the tantalum lead-out wire 11 to the longitudinal length Wb of the cross section of the capacitor element 10. Thus, the greater the value of Wa/Wb, the larger the area where the tantalum lead-out wire 11 and the anode body 12 of the capacitor element 10 are brought into contact with each other becomes. Therefore, it is considered that the greater the value of Wa/Wb, the larger the area where the tantalum lead-out wire 11 and the anode body 12 of the capacitor element 10 are brought into contact with each other becomes, which reduces the contact resistance, and the lower the impedance value of the solid electrolytic capacitor becomes.

On the other hand, when the value of Wa/Wb is high, the longitudinal length Wa of the cross section of the tantalum lead-out wire 11 is long. As described above, when the longitudinal length Wa of the cross section of the tantalum lead-out wire 11 becomes long, there is a possibility that the pellet crack failure rate may become high. In consideration of this point, the value of Wa/Wb may be 0.3 or more and 0.7 or less.

The noise filter including the solid electrolytic capacitor disclosed in Japanese Unexamined Patent Application Publication No. 2004-7105 is intended to maintain a low impedance in a high frequency region, but the noise filter cannot sufficiently satisfy a demand for further reduction in the size and thickness and a low impedance in a high frequency region. Specifically, in the noise filter disclosed in Japanese Unexamined Patent Application Publication No. 2004-7105, since the tantalum thin wire has a cylindrical structure, that is, the cross-sectional shape of the tantalum thin wire is circular, the influence of Equivalent Series Inductance (ESL) and Equivalent Series Resistance (ESR) becomes large in the high frequency region, and the impedance in the high frequency region could not be sufficiently reduced in some cases.

On the other hand, in the solid electrolytic capacitor 1 according to this embodiment, by setting the value of YA/PA and/or the value of Wa/Wb within the above range, it is possible to increase the contact area between the anode body 12 of the capacitor element 10 and the tantalum lead-out wire 11. This reduces the contact resistance between the anode body 12 and the tantalum lead-out wire, and the value of the impedance of the solid electrolytic capacitor. Furthermore, in the solid electrolytic capacitor 1 according to this embodiment, the surface area of the tantalum lead-out wire can be increased by setting the value of YA/PA within the above range. This configuration takes into consideration the skin effect in which current tends to flow through a surface side of a conductor in a high frequency region. By increasing the surface area of the tantalum lead-out wire, that is, by increasing the cross-sectional area through which current flows, the resistance in the high frequency region becomes low, and the value of the impedance of the solid electrolytic capacitor can be reduced.

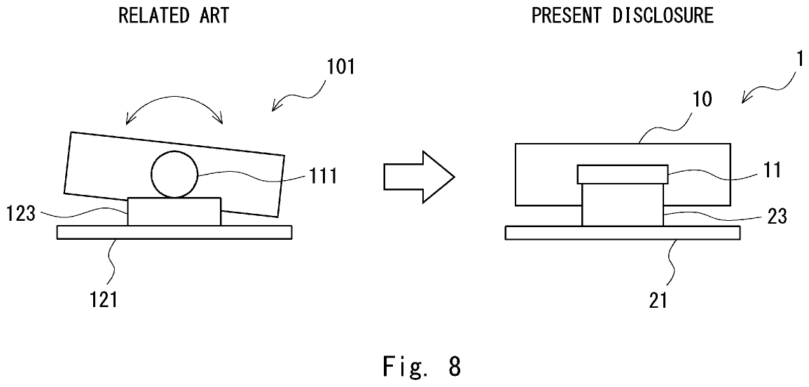

The advantages of the present disclosure are further described with reference to FIGS. 8 to 10.

As shown in the left drawing of FIG. 8, in a solid electrolytic capacitor 101 according to related art, a tantalum lead-out wire 111 has a cylindrical structure, that is, a cross-sectional shape of the tantalum lead-out wire 111 is circular. Thus, a part where an erected part 123 erected from a pedestal part 121 is brought into contact with the tantalum lead-out wire 111 is a point, and the solid electrolytic capacitor becomes unstable. For this reason, the solid electrolytic capacitor 101 is inclined, and when the cathode body is adhered to the cathode terminal using a conductive adhesive, there are cases where an adhesion failure or an exposure failure in which the capacitor element is exposed from an exterior resin occurs.

On the other hand, in the solid electrolytic capacitor 1 according to this embodiment, as shown in the right drawing of FIG. 8, the tantalum lead-out wire 11 has a rectangular cross section. Thus, the part where the erected part 23 is brought into contact with the tantalum lead-out wire 11 is linear, and the solid electrolytic capacitor is stable. It is thus possible to eliminate or minimize an occurrence of an adhesion failure and an exposure failure. Specifically, when the tantalum lead-out wire 111 has a cylindrical structure, the exposure failure rate is 5.0%. On the other hand, when the tantalum lead-out wire 11 has a rectangular cross section as in this embodiment, the exposure failure rate is 0.1%, meaning a reduced occurrence of the exposure failure.

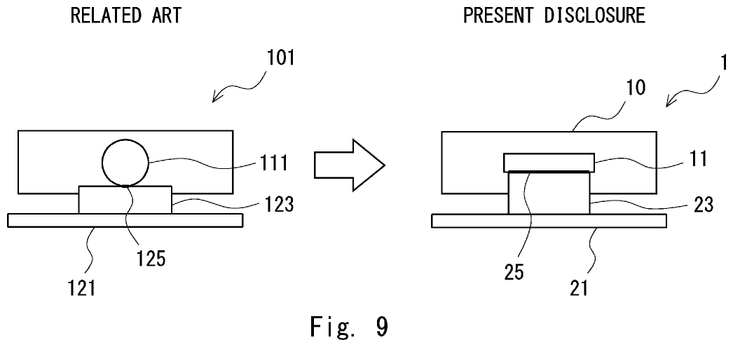

As shown in the left drawing of FIG. 9, a part where the solid electrolytic capacitor 101 according to the related art is brought into contact to the erected part 123 and the tantalum lead-out wire 111 is a point, and thus the solid electrolytic capacitor 101 according to the related art is electrically connected to the erected part 123 and the tantalum lead-out wire 111 at the point. Therefore, there is a problem that the connection resistance between the tantalum lead-out wire 111 and the erected part 123 is increased. If the connection resistance is increased in this manner, the passing resistance, which is the resistance between the two anode terminals, specifically, in FIG. 1, the resistance between the pedestal part 21a—the erected part 23a—the tantalum lead-out wire 11—the erected part 23b—the pedestal part 21b, is also increased. If the passing resistance is high, the heat generated inside a product may increase, resulting in an adverse effect on product quality.

On the other hand, in the solid electrolytic capacitor 1 according to this embodiment, as shown in the right drawing of FIG. 9, the tantalum lead-out wire 11 has a rectangular cross section. Thus, the part where the erected part 23 is brought into contact with the tantalum lead-out wire 11 has a linear shape, and the connection is a surface connection. Therefore, the connection resistance between the tantalum lead-out wire 11 and the erected part 23 can be reduced. Specifically, when the tantalum lead-out wire 111 has a cylindrical structure, the passing resistance is 7.5 mΩ. On the other hand, when the cross section of the tantalum lead-out wire 11 is rectangular as in this embodiment and the connection resistance is made low, the passing resistance can be reduced to as low as 6.8 mΩ.

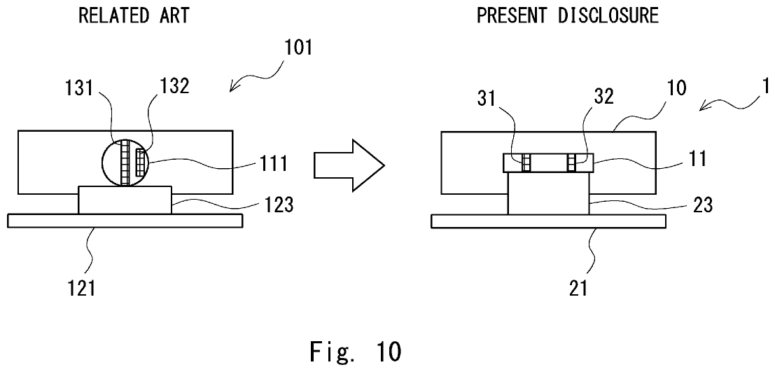

Further, as shown in the left drawing of FIG. 10, in the solid electrolytic capacitor 101 according to the related art, the tantalum lead-out wire 111 has a cylindrical structure, that is, a cross-sectional shape of the tantalum lead-out wire 111 is circular. Thus, there are cases where a welding failure occurs when the tantalum lead-out wire 111 is welded to the erected part 123. That is, when the tantalum lead-out wire 111 has a cylindrical structure, the volume of the wire to be melted varies depending on a laser irradiated position, so that the wire is melted unevenly. For example, in a central part 131 of the tantalum lead-out wire 111, since the volume of the wire to be melted is large, the wire is hard to be melted. On the other hand, at an end side 132 of the tantalum lead-out wire 111, since the volume of the wire to be melted is small, the wire is easily melted. As described above, when the tantalum lead-out wire 111 has a cylindrical structure, the ease of melting the wire is different depending on the laser irradiated position, and thus a welding failure sometimes occurs.

On the other hand, in the solid electrolytic capacitor 1 according to this embodiment, as shown in the right drawing of FIG. 10, since the tantalum lead-out wire 11 has a rectangular cross section, when the erected part 23 and the tantalum lead-out wire 11 are welded, the wire can be melted uniformly regardless of the laser irradiated position. For example, a volume of the wire to be melted at a laser irradiated position 31 and that at a laser irradiated position 32 are the same, and thus the volume of the wire to be melted is the same. Thus, the tantalum lead-out wire 11 can be stably welded to the erected part 23. Specifically, when the tantalum lead-out wire 111 has a cylindrical structure, an open failure rate is 1.5%. On the other hand, when the tantalum lead-out wire 11 has a rectangular cross section as in this embodiment, the open failure rate is 0.1% or less, and the tantalum lead-out wire 11 can be stably welded to the erected part 23.

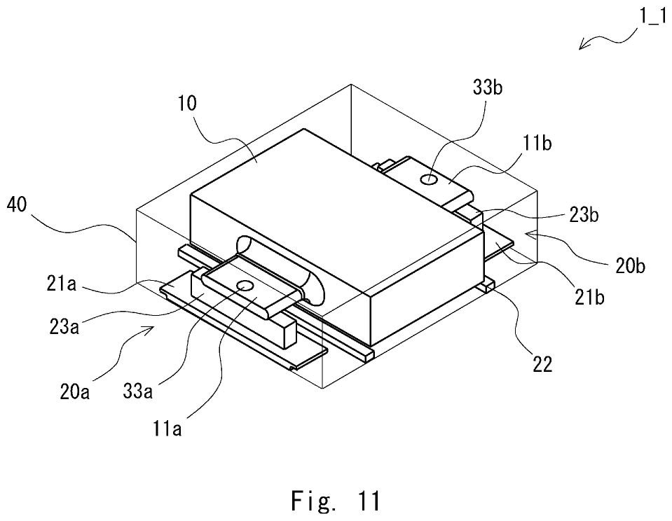

Next, a configuration example of the solid electrolytic capacitor according to this embodiment will be described. FIGS. 11 to 15 are perspective views showing a configuration example of the solid electrolytic capacitor according to this embodiment.

A solid electrolytic capacitor 1_1 shown in FIG. 11 includes a capacitor element 10 and tantalum lead-out wires 11a and 11b. The tantalum lead-out wires 11 penetrate the capacitor element 10 in the penetrating direction. The tantalum lead-out wires 11a and 11b are connected to anode lead frames 20a and 20b, respectively. The anode lead frames 20a and 20b include pedestal parts 21a and 21b, respectively, and erected parts 23a and 23b erected vertically from the pedestal parts 21a and 21b, respectively. In the configuration example shown in FIG. 11, the erected parts 23a and 23b are bonded to the pedestal parts 21a and 21b, respectively, by welding or the like.

The tantalum lead-out wires 11a and 11b are welded to the erected parts 23a and 23b at the welded parts 33a and 33b, respectively. The cathode body 15 (see FIG. 3) of the capacitor element 10 is electrically connected to the cathode terminal 22 on the lower surface side of the capacitor element 10. The solid electrolytic capacitor 1_1 is covered with an exterior resin 40. By providing the exterior resin 40, the solid electrolytic capacitor 1_1 can be protected from the external environment.

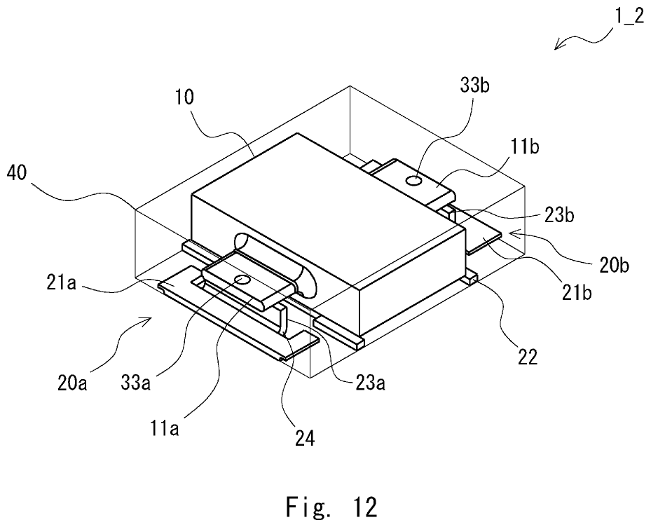

A solid electrolytic capacitor 1_2 shown in FIG. 12 includes a capacitor element 10 and tantalum lead-out wires 11a and 11b. The tantalum lead-out wires 11a and 11b are connected to anode lead frames 20a and 20b, respectively. In the configuration example shown in FIG. 12, the erected parts 23a and 23b are formed by bending parts of the pedestal parts 21a and 21b, respectively. That is, at bending positions 24 of the pedestal parts 21a and 21b, the parts of the pedestal parts 21a and 21b are bent outward from the capacitor element 10 side to form the erected parts 23a and 23b, respectively. The configuration other than this is the same as that of the solid electrolytic capacitor 1_1 shown in FIG. 11. In the configuration example shown in FIG. 12, since the erected parts 23a and 23b are formed by bending the parts of the pedestal parts 21a and 21b, respectively, manufacturing of the anode lead frames 20a and 20b can be simplified.

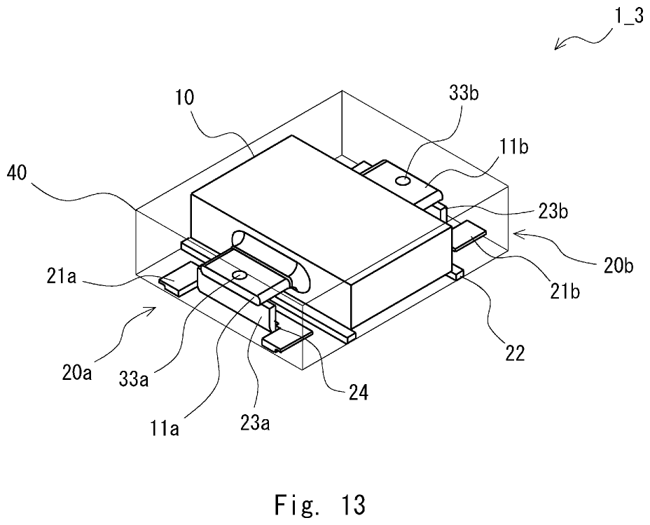

A solid electrolytic capacitor 1_3 shown in FIG. 13 includes a capacitor element 10 and tantalum lead-out wires 11a and 11b. The tantalum lead-out wires 11a and 11b are connected to anode lead frames 20a and 20b, respectively. In the configuration example shown in FIG. 13, the erected parts 23a and 23b are formed by bending parts of the pedestal parts 21a and 21b, respectively. That is, at the bending positions 24 of the pedestal parts 21a and 21b, the parts of the pedestal parts 21a and 21b are bent from the outside toward the capacitor element 10 side to form the erected parts 23a and 23b, respectively. The configuration other than this is the same as that of the solid electrolytic capacitor 1_1 shown in FIG. 11. In the configuration example shown in FIG. 13, since the erected parts 23a and 23b are formed by bending the parts of the pedestal parts 21a and 21b, respectively, manufacturing of the anode lead frames 20a and 20b can be simplified.

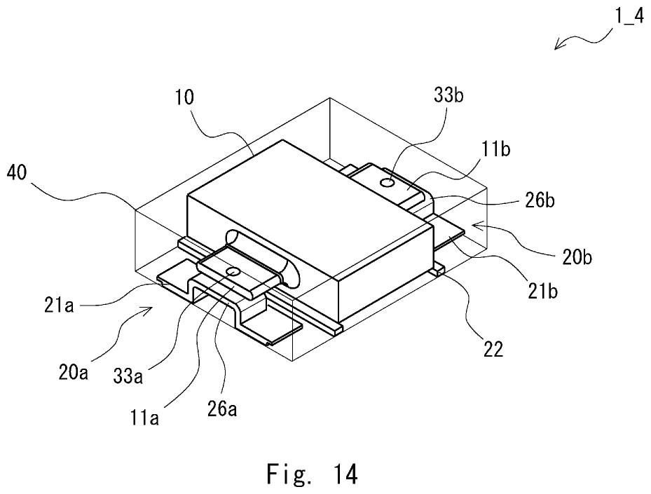

A solid electrolytic capacitor 1_4 shown in FIG. 14 includes a capacitor element 10 and tantalum lead-out wires 11a and 11b. The tantalum lead-out wires 11a and 11b are connected to anode lead frames 20a and 20b, respectively. In the configuration example shown in FIG. 14, the anode lead frames 20a and 20b have erected parts 26a and 26b, respectively, formed by forming parts, specifically, central parts, of the pedestal parts 21a and 21b, respectively, into U-shape cross sections. The erected parts 26a and 26b can be formed by drawing, which will be described later in detail, or bending. The respective tantalum lead-out wires 11a and 11b are welded to the erected parts 26a and 26b at the welded parts 33a and 33b, respectively.

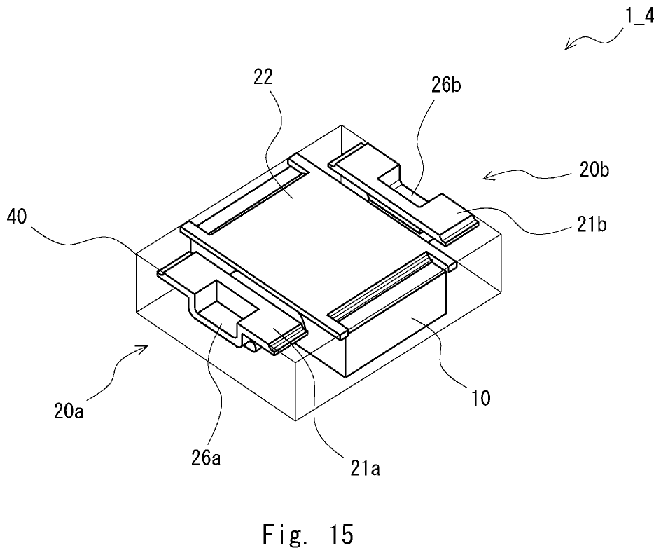

FIG. 15 is a perspective view of the solid electrolytic capacitor 1_4 shown in FIG. 14 as viewed from the rear surface side. As shown in FIG. 15, in the anode lead frames 20a and 20b of the solid electrolytic capacitor 1_4, the erected parts 26a and 26b are formed with the parts welded to the tantalum lead-out wires 11a and 11b, respectively, as U-shape cross sections. The pedestal parts 21a and 21b are formed at parts closer to the capacitor element 10 than the erected parts 26a and 26b without forming U-shape cross sections. With such a configuration, the mounting area of the anode terminals, i.e., the pedestal parts 21a and 21b, can be increased. The configuration other than this is the same as that of the solid electrolytic capacitor 1_1 shown in FIG. 11. In the configuration example shown in FIGS. 14 and 15, the central parts of the pedestal parts 21a and 21b have U-shaped cross sections to form the erected parts 26a and 26b, respectively, and thus the manufacturing of the anode lead frames 20a and 20b can be simplified.

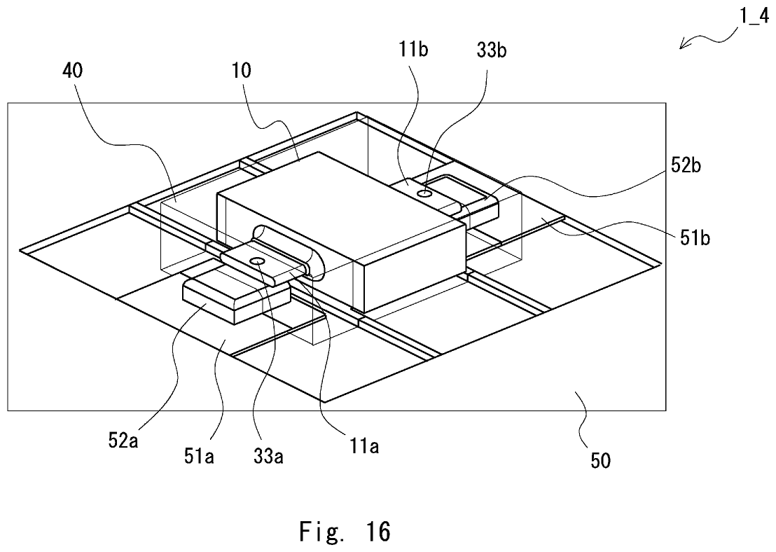

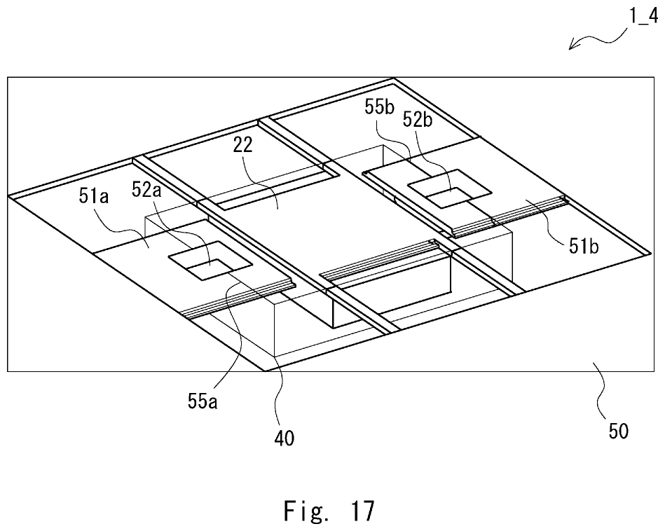

FIGS. 16 and 17 are perspective views for explaining a manufacturing example of the solid electrolytic capacitor according to this embodiment, and are views for explaining a manufacturing example of the solid electrolytic capacitor 1_4 shown in FIGS. 14 and 15. FIG. 16 is a perspective view of the solid electrolytic capacitor 1_4 as viewed from the upper surface side. FIG. 17 is a perspective view of the solid electrolytic capacitor 1_4 as viewed from the rear surface side.

As shown in FIG. 16, when the solid electrolytic capacitor 1_4 is manufactured, first, regions 51a and 51b of a plate-like member 50 are drawn to form protrusions 52a and 52b, respectively. The protrusions 52a and 52b correspond to the erected parts 26a and 26b, respectively, shown in FIGS. 14 and 15. After that, the capacitor element 10 is arranged so that the upper surfaces of the protrusions 52a and 52b and the lower surfaces of the tantalum lead-out wires 11a and 11b are brought into contact with each other, respectively.

Next, welding parts 33a and 33b of the tantalum lead-out wires 11a and 11b are irradiated with laser beams to weld the tantalum lead-out wires 11a and 11b to the protrusions 52a and 52b, respectively. After that, the exterior resin 40 is formed to cover the capacitor element 10 and the tantalum lead-out wires 11a and 11b. At this time, the exterior resin 40 is prevented from entering the rear surface side of the projections 52a and 52b (see FIG. 17). Then, the solid electrolytic capacitor 1_4 shown in FIGS. 14 and 15 can be formed by cutting by dicing at cutting positions 55a and 55b shown in FIG. 17.

In the solid electrolytic capacitor 1_4 shown in FIGS. 14 and 15, the rear surfaces of the erected parts 26a and 26b, which corresponds to the rear surfaces of the protrusions 52a and 52b in FIGS. 16 and 17, respectively, are hollow. Therefore, when the solid electrolytic capacitor 1_4 is mounted, the solder flows into the space on the rear surface side of the erected parts 26a and 26b, which facilitates the formation of the solder fillet, so that the mounting area of the solid electrolytic capacitor 1_4 can be reduced and the solid electrolytic capacitor 1_4 can be surely mounted on the substrate.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion.

1. A solid electrolytic capacitor comprising:
a tantalum lead-out wire; and
a capacitor element including:
an anode body formed of a valve metal and covering a periphery of a middle part of the tantalum lead-out wire;
a dielectric layer formed on a surface of the anode body;
a solid electrolyte layer formed on a surface of the dielectric layer; and
a cathode body formed on a surface of the solid electrolyte layer, wherein
the tantalum lead-out wire penetrates the capacitor element in a penetrating direction,
cross sections of the tantalum lead-out wire and the capacitor element perpendicular to the penetrating direction include a rectangular shape, a longitudinal direction of the cross sections extending in a horizontal direction, and
a value of Wc/Wd is less than 0.5, where We is a vertical length of the cross section of the tantalum lead-out wire perpendicular to the penetrating direction and Wd is a vertical length of the cross section of the capacitor element perpendicular to the penetrating direction.

2. The solid electrolytic capacitor according to claim 1, wherein
the value of Wc/Wd is 0.3 or less.

3. The solid electrolytic capacitor according to claim 1, wherein
the value of Wc/Wd is 0.1 or more and 0.3 or less.

4. The solid electrolytic capacitor according to claim 1, wherein
a value of YA/PA is 0.1 or more and 0.9 or less, where YA is a length of a circumference of the cross section of the tantalum lead-out wire perpendicular to the penetrating direction and PA is a length of a circumference of the cross section of the capacitor element perpendicular to the penetrating direction.

5. The solid electrolytic capacitor according to claim 4, wherein
the value of YA/PA is 0.3 or more and 0.7 or less.

6. The solid electrolytic capacitor according to claim 1, wherein
a value of Wa/Wb is 0.2 or more and 0.8 or less, where Wa is a horizontal length of the cross section of the tantalum lead-out wire perpendicular to the penetrating direction, and Wb is a horizontal length of the cross section of the capacitor element perpendicular to the penetrating direction.

7. The solid electrolytic capacitor according to claim 6, wherein
the value of Wa/Wb is 0.3 or more and 0.7 or less.

8. The solid electrolytic capacitor according to claim 1, wherein
the tantalum lead-out wire constitutes a first anode lead-out wire and a second anode lead-out wire on both sides of the capacitor element in the penetrating direction,
the first anode lead-out wire is welded to a first anode lead frame erected from a substrate, and
the second anode lead-out wire is welded to a second anode lead frame erected from the substrate.

9. The solid electrolytic capacitor according to claim 8, wherein
each of the first anode lead frame and the second anode lead frame includes a pedestal part connected to the substrate, and an erected part formed by bending a part of the pedestal part, and
the first anode lead-out wire and the second anode lead-out wire are welded to the erected part of the first anode lead frame and the erected part of the second anode lead frame, respectively.

10. The solid electrolytic capacitor according to claim 8, wherein
each of the first anode lead frame and the second anode lead frame includes a pedestal part connected to the substrate, and an erected part having a U-shape cross section formed in a part of the pedestal part, and
the first anode lead-out wire and the second anode lead-out wire are welded to the erected part of the first anode lead frame and the erected part of the second anode lead frame, respectively.
